(19) United States
(12) Patent Application Publication
(10) Pub. No.: US 2026/0363424 A1
(43) Pub. Date: Nov. 19, 2026

(54) BRUSH AND A METHOD OF FABRICATION THEREOF

(71) Applicant: GARANT GP, Saint-François (CA)

(72) Inventor: Carl BLOUIN, Lévis (CA)

(21) Appl. No.: 19/210,243

(22) Filed: May 16, 2025

(51) Int. Cl. A46B 5/00; A46B 5/06; A46B 9/00; B25G 1/04

(52) U.S. Cl. CPC A46B 5/0058; A46B 5/005; A46B 5/06; A46B 9/005; A46B 2200/30; B25G 1/04

(57) ABSTRACT

A brush, comprising a shaft; a board symmetrically supported by the shaft; the board has at least one front plate symmetrically positioned on its front surface and connected to the shaft forward of the board; and back plates on its back surface and each connected by respective stretchers to the shaft rearward of the back surface. In the spread out position, the board extends with the lateral sides thereof away from the shaft on each side of the shaft. In the folded position, each one of the lateral sides of the board folds backwards towards alignment with the shaft on a respective side of the shaft, under a pulling action of the stretchers backwards on the shaft; and, reversely, a sliding movement of the stretchers forward on the shaft pushes the lateral sides of the board away from the shaft to the spread out position.

### FIELD OF THE INVENTION

The present invention relates to brushes. More specifically, the present invention is concerned with a brush and a method of fabrication thereof.

### BACKGROUND OF THE INVENTION

Brushes typically comprise bristles heads. The bristle head may be in two separate sections configured to fold backwards on each side of the shaft of the brush, for storage for example, and spreads out for deployment at the tip of the shaft for use, bristles from the two joined bristles head sections overlapping at the tip of the brush, thereby, so that the front surface of the brush is continuous.

Brushes may also comprise heads in two separate sections made in a solid material instead of bristles and folding backwards in a similar manner. However, once spread out at the tip of the brush, the two sections typically join with a discontinuity therebetween, resulting in a dead zone in the center, and thus in a brushing surface and edge having a discontinuity in the center. Other brushes comprise a one part head that rotates 90 degrees about a pivot of the brush shaft, so as to position alongside the brush shaft for storage; they provide continuous brushing surface and edge, with no dead zone. However, even when in the storage position, they remain bulky as typically half the head largest length is added to the length of the shaft. Moreover, in case of snow brushes for examen, snow may end up unevenly distributed about the brush head surface, which may cause increased torsional load on the pivot of the brush head.

There is still a need in the art for a brush and a method of fabrication thereof.

### SUMMARY OF THE INVENTION

More specifically, in accordance with the present invention, there is provided a brush, comprising a shaft; a board having lateral sides, a bottom edge, a back surface and a front surface, and symmetrically supported by the shaft; at least one front plate symmetrically positioned on the front surface of the board relative to the lateral sides and connected to the shaft forward of the board; and a first and a second back plates on the back surface, each one of the back plates being connected to the shaft by respective stretchers slidingly connected to the shaft rearward of the back surface; wherein the brush is configured to be in at least one of : i) a spread out position and ii) a folded position; and i) in the spread out position, the board extends with the lateral sides thereof away from the shaft on each side of the shaft; ii)in the folded position, each one of the lateral sides of the board folds backwards towards alignment with the shaft on a respective side of the shaft about the hinge, under a pulling action of the stretchers backwards on the shaft; and, reversely, a sliding movement of the stretchers forward on the shaft pushes the lateral sides of the board away from the shaft.

There is further provided a tool, comprising a pole and a brush head a distal end of the pole, wherein the brush head comprises a shaft, the shaft having a transverse cross transverse cross section larger than a transverse cross transverse cross section of the pole; a board supported by the shaft proximate a tip end of the shaft; at least one front plate symmetrically positioned on the front surface of the board relative to the lateral sides and connected to the shaft forward of the board; a first and a second back plates on the back surface, each one of the back plates being connected to the shaft by respective stretchers slidingly connected to the shaft rearward of the back surface; wherein the brush in configured to be in at least one of : i) a spread out position and ii) a folded position; and i)in the spread out position, the board extends with the lateral sides thereof away from the shaft on each side of the shaft; ii) in the folded position, each one of the lateral sides of the board folds backwards towards alignment with the shaft on a respective side of the shaft, under a pulling action of the stretchers backwards on the shaft; and, reversely, a sliding movement of the stretchers forward on the shaft pushes the lateral sides of the board away from the shaft.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a top view of a tool in an extended position thereof with a tool head thereof in a spread out position, according to an embodiment of an aspect of the present disclosure;

FIG. 2 is a perspective side view of a tool in a retracted position thereof with a tool head thereof in a spread out position, showing the continuous bottom edge of the brush of the tool head according to an embodiment of an aspect of the present disclosure;

FIG. 3 is a perspective side view of a tool in a folded position thereof with a tool head thereof in a folded position, according to an embodiment of an aspect of the present disclosure;

FIG. 4 is bottom view of a tool head in a spread out position thereof, according to an embodiment of an aspect of the present disclosure;

FIG. 5 is a top view of a tool in an extended position thereof with a tool head thereof in a spread out position and schematically showing collapsing the tool head according to an embodiment of an aspect of the present disclosure;

FIG. 6A is a top view of FIG. 3;

FIG. 6B is the tool with the pole extended from the position of FIG. 6A as a result of drawing the pole out of the shaft of the tool head as shown by the arrow in FIG. 6A, the arrow in FIG. 6B indicating the movement of the pole sliding into the shaft of the tool head back into the position of FIG. 6A according to an embodiment of an aspect of the present disclosure;

FIG. 7A is an exploded view of a tool head according to an embodiment of an aspect of the present disclosure;

FIG. 7B is a perspective top view of a tool head in a spread out position thereof according to an embodiment of an aspect of the present disclosure;

FIG. 8A is a top view of a tool head in a spread out position thereof according to an embodiment of an aspect of the present disclosure;

FIG. 8B is a bottom view of the tool head of FIG. 8A, showing the continuous bottom edge of the brush of the tool head;

FIG. 8C is a bottom view of the tool head of FIG. 8A, once folded as indicated by arrows in FIG. 8B; and

FIG. 9 is a sectional view of the shaft of a tool head according to an embodiment of an aspect of the present disclosure.

### DESCRIPTION OF ILLUSTRATIVE EMBODIMENTS

The present invention is illustrated in further details by the following non-limiting examples for a snowbrush. Other brushes may be contemplated, such as squeegees for example.

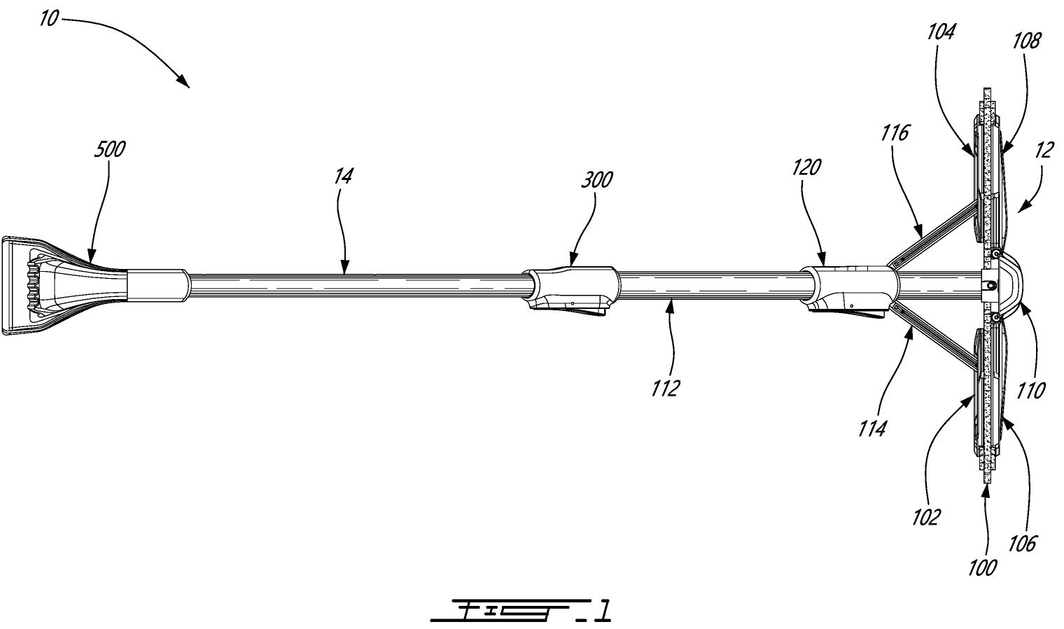

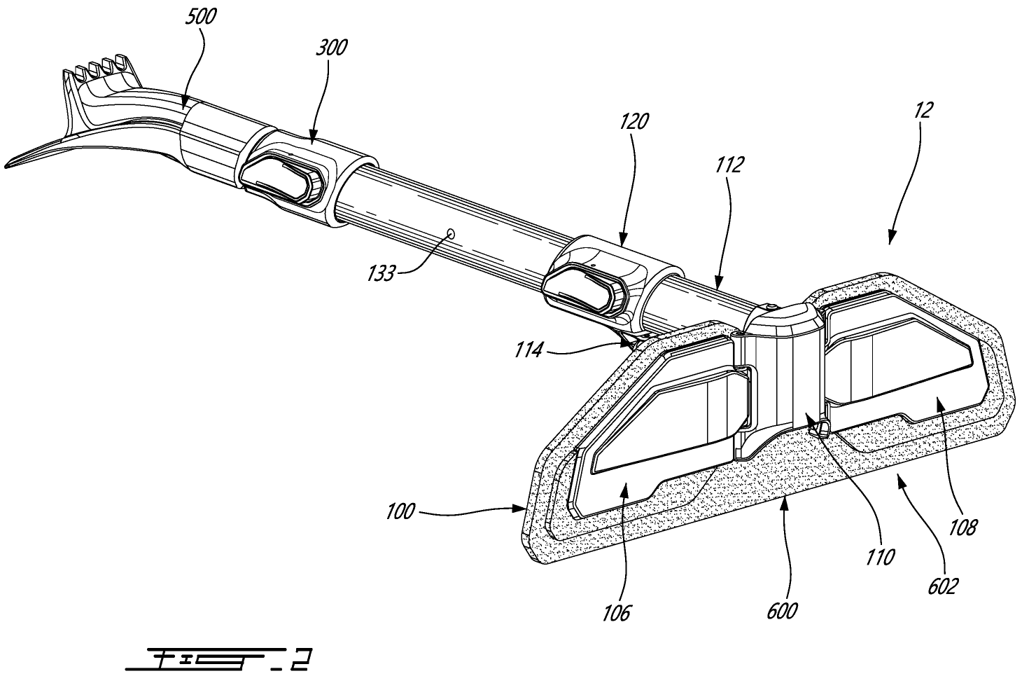

A snowbrush 10 according to an embodiment of an aspect of the present disclosure comprises a brush head 12 at a distal end of a pole 14. The brush head 12 comprises a brush 100 supported at a free end of a shaft 112. The shaft 112 has a transverse cross section larger than the transverse cross section for the pole 14. The brush 100 is generally symmetrically positioned relative to the shaft 112, thus extending generally symmetrical on each side of the shaft 112 in a spread out position thereof as in FIGS. 1, 2,4,5, 7, 8A and 8B for example. In FIGS. 2, 3 and 6A, the pole 14 is in a retracted position, fitting snugly inside the shaft 112 of the brush head 12.

A scraper 500 is shown at a proximal end of the pole 14 for illustration purposes.

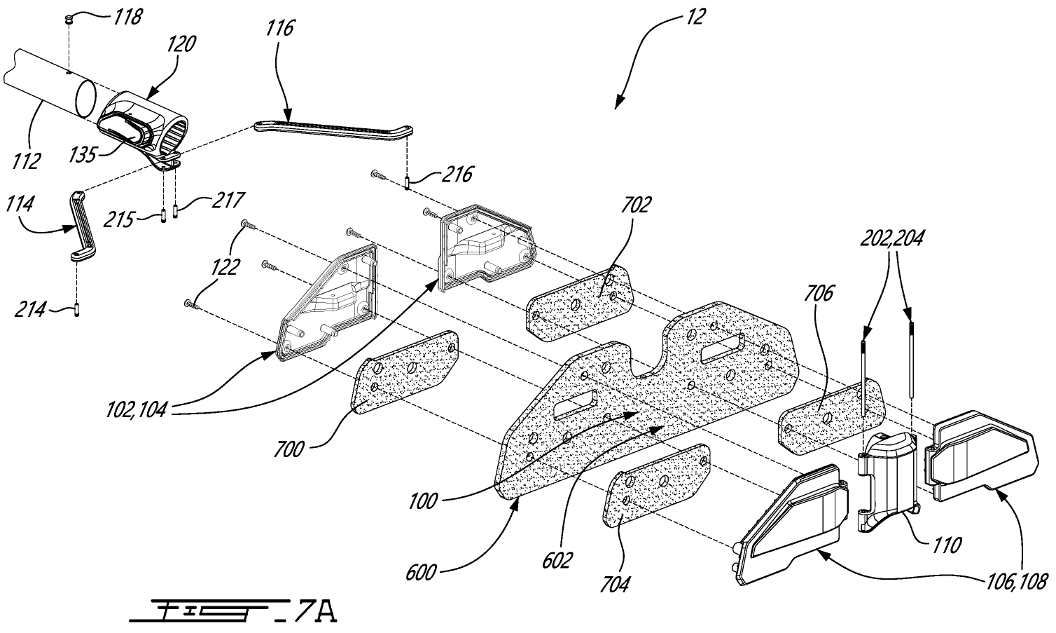

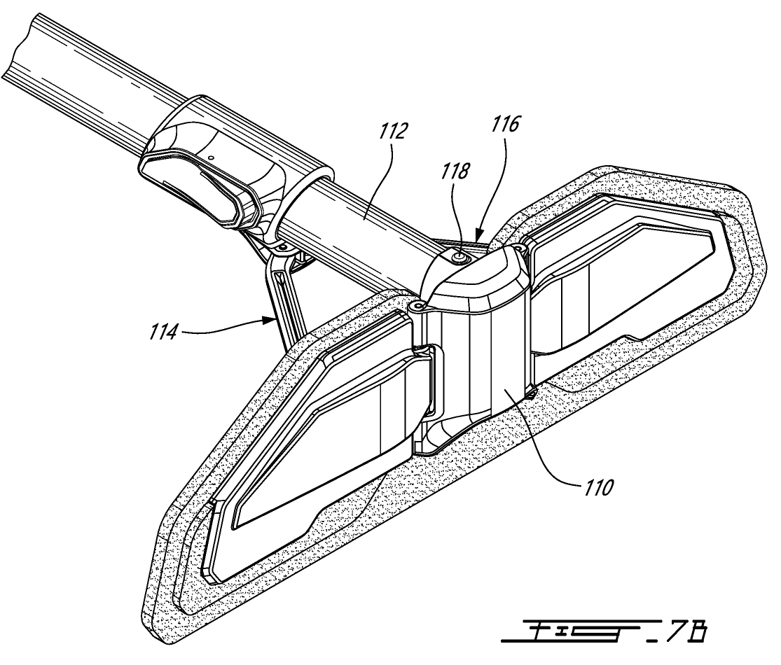

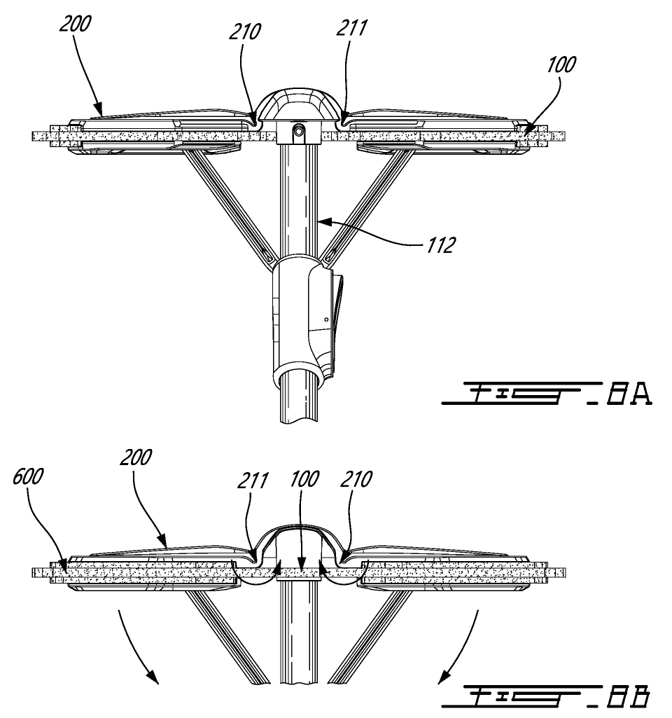

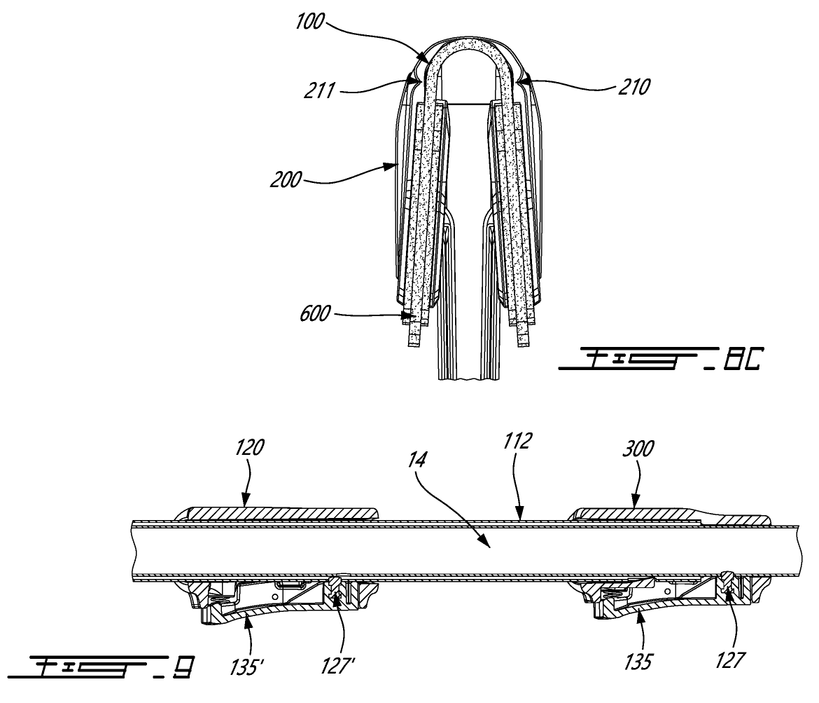

As best seen in FIG. 7A, the brush 100 is a board of material spanning from lateral sides symmetrical on each side of the shaft, and having a bottom edge 600. The board may have a varying thickness from its lateral sides thereof to a center part thereof at the pole 112, and/or comprise symmetrically positioned reinforcements (see for example 700,702 and 704, 706). The board comprises back plates 102,104 symmetrically positioned on a back surface thereof; and at least one front plate positioned on a front surface 602 thereof and connected to the shaft forward of said board, for example two front plates 106, 108 for example, symmetrically positioned on a front surface 602 thereof and connected to the shaft forward of said board, by hinge pins as discussed in relation to FIG. 7 hereinbelow for example, or one front plate as discussed in relation to FIGS. 8 hereinbelow for example. The brush 100 is allowed to fold for collapsing backwards on each side of the shaft 112 and unfold for deployment forwards on each side of the shaft 112 as will be detailed hereinbelow.

As shown in FIGS. 7 for example, the back and front plates 102, 104, and 106, 108 may be secured to the board using screws 122; each one of front plates 106, 108 is connected on a respective side of the socket 110 on a respective side of the shaft 112, using hinge pins 202, 204 as illustrated for example, to a socket 110 symmetrically mounted at the distal end of the shaft 112. The socket 110 is symmetrically mounted at the distal end of the shaft 112 using rivet 118 on the respective side of the hinge socket 110 for example. Each one of the back plates 102, 104 is connected to a button 120 slidingly mounted about the shaft 112 using pins 214, 215, 216, 217 as shown in FIG. 7A for example, by a respective radiating stretcher 114, 116, the stretchers pivot for the deployment of the brush as will be described hereinbelow.

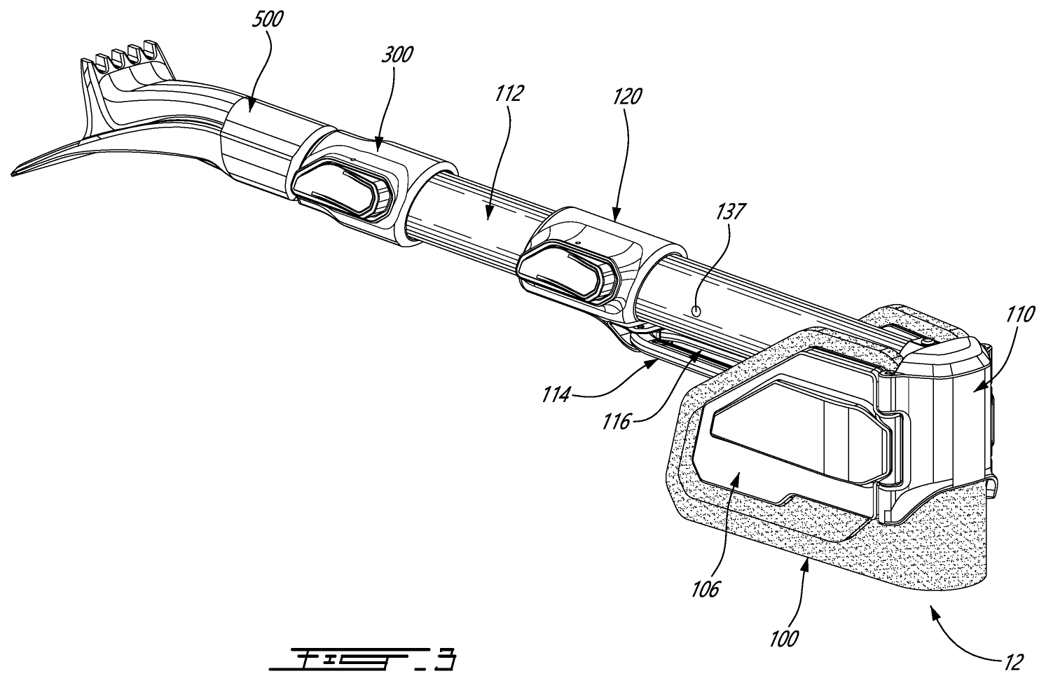

The sliding button 120 comprises a press button 135 with integrated pin 127 configured to insert into apertures 133 or 137 in the shaft 112 (best seen in FIG. 9) to lock in positions of FIGS. 2 or 3 respectively for example. The press button 135 flips when pressed, thereby releasing the pin 127 out of the corresponding aperture 133, 137 in the shaft 112, thus releasing the axial movement of the sliding button 120 along the shaft 112. The pin 127 may be a metallic pin, or a plastic pin, overmolded onto the press button 135 as best seen in the sectional view in FIG. 9 for example.

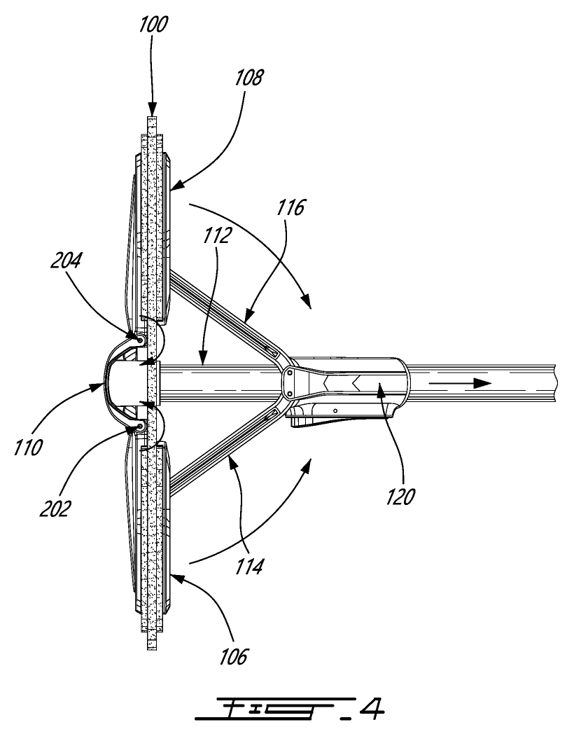

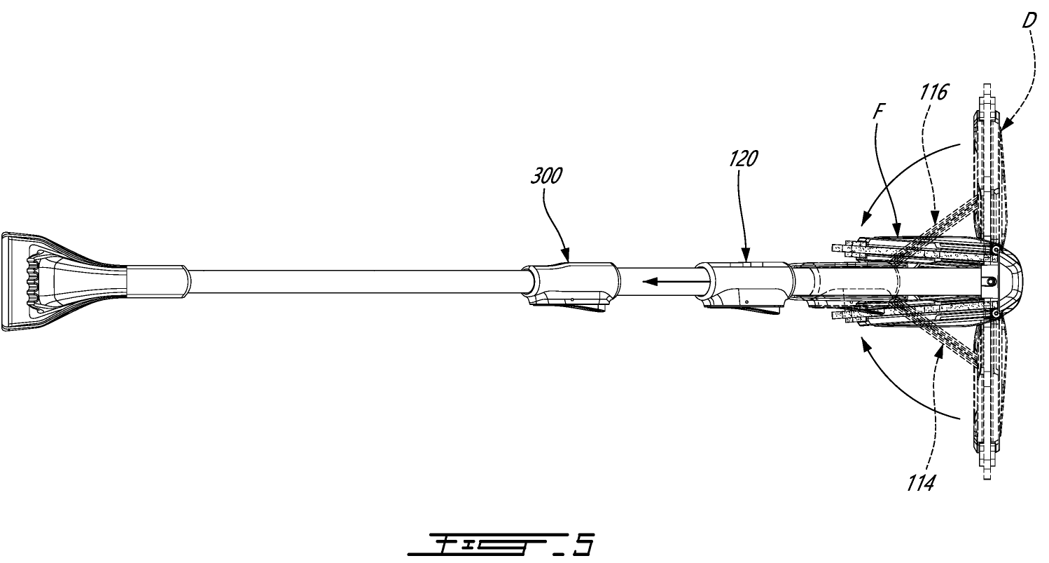

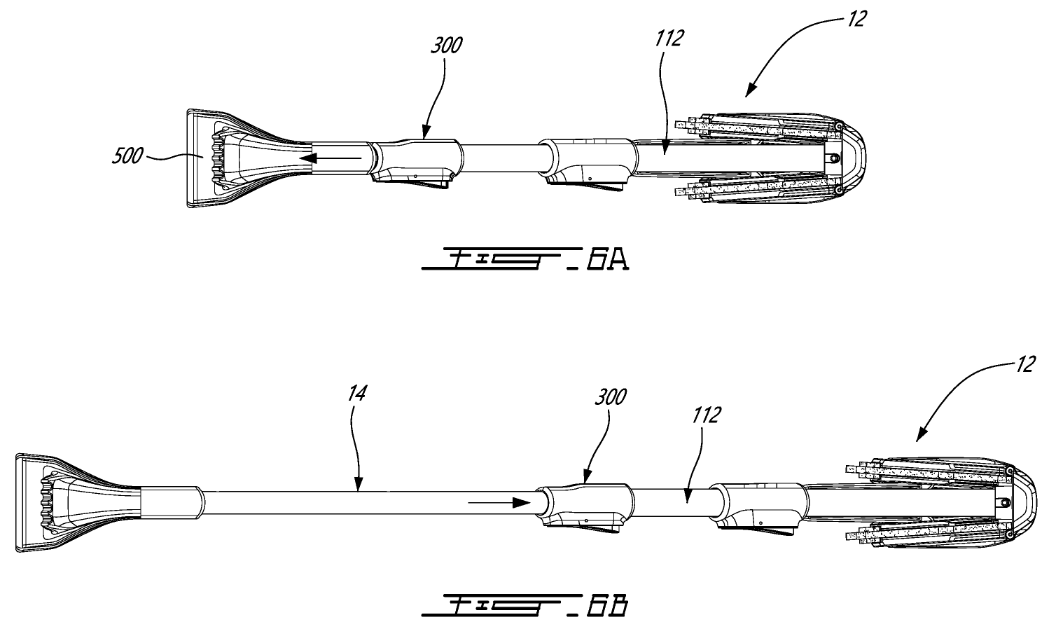

The brush extending on each side of the shaft 112 in a spread out position of the brush head in FIG. 4 may be folded backwards, about hinge pins 202, 204 of the socket 110, into alignment with the shaft 112 on each side of the shaft 112, under a pulling action of the stretchers 114, 116 initiated by drawing the stretchers 114, 116, into alignment with the shaft 112 on each side of the shaft 112 upon sliding the sliding button 120 rearward on the shaft 112 (see FIGS. 4, 5) into a folded position of the brush shown for example in FIGS. 3 and 6. Thus, the user may fold the brush backwards to a folded position on each side of the shaft 112, for storage for example. Reversely, for use of the brush, the user slides the sliding button 120 forward, thereby pivoting the stretchers 114, 116 away from the shaft 112, which deploys the lateral sides of the board away from the shaft 112.

Alternatively, the two front plates 106, 108, the socket 110 and the two hinge pins 202, 204 described hereinabove may be replaced by a front plate 200 spanning symmetrically relative to the shaft 112 as schematically FIGS. 8 for example, and comprising living hinges 210, 211 positioned so as to allow the front plate 200 to fold back or forward for collapsing or deploying the brush on each side of the shaft 112. as described hereinabove.

The front and back plates may be made in a plastic material for example.

The pole 14 is configured to telescopically move in and out of the shaft 112 at a proximal end of the shaft 112. The pole 14 may thus be received within the shaft 112 (see FIGS. 2, 3, 6A for example) and extended out from the proximal end of the shaft 112 (see FIGS. 1, 5, 6B for example), by releasing a button 300 fixedly mounted at the end of the shaft 112 opposite the tip end of the shaft 112, thereby allowing the use of the full length of the shaft 112 from the scraper in a fully extended position of the tool, while allowing insertion of the pole 14 within the shaft 112 for a shorter shafted tool. In a similar way as discussed hereinabove in relation to the sliding button 120 (see FIG. 9: pin 127’, press button 135’) and apertures on the shaft 112 of the tool head, the pole 14 may thus be locked in a first extended position by locking the pin 127 into a first aperture or in a position at mid-length thereof for example, or at as any number of intermediate positions, by locking the pin 127 into a second aperture in the pole 14 (apertures on the shaft 14 not shown).

The pole 14 and the shaft 112 may be tubular members or of cross sections selected so that the pole 14 can slide in and out of the shaft 112, in aluminum, steel, plastic, fiberglass, wood, or steel for example.

The selected position of the hinge pins 202, 204 of the, or of the living hinges 210, 211, forwards of the front plates, or of the front plate, at the tip end of the tool head as best seen in FIGS. 4 and 8 allows collapse of the brush 100 backwards without stretching the material of the brush. FIG. 4 shows the position of the board 100 relative to the hinge pins 202, 204; when folding, the material at the center of the board 100 is allowed space for a folding curvature ahead of the hinge pins 202, 204, which prevents stretching. Similarly, FIGS. 8C shows the position of the board 100 relative to the living hinges 210, 211 and how, when folded, the material of the brush is provided room for a curvature forward at the center of the board 100 in such a way that each lateral sides may fold back without stretching tension applied thereto.

Moreover, the material of the brush thus protruding at the tip of the shaft in a folded position of the brush provides a convex surface that may be used to reach snow in areas that may be more difficult to reach with the front surface of the brush in a spread out position, for example in the gutters below the windshield wipers. The socket 110 provides a grip for handling the tool when using the ice scraper positioned at its proximal end opposite the tool head.

When the brush 100 is brought into its fully spread out position at the end tip of the shaft 112, upon extending the stretchers 114, 116 away from alignment with the shaft 112 by sliding the button 120 forward on the shaft 112, the front surface 602 of the brush is continuous, with a continuous bottom edge 600, without dead zone in the center thereof, available for contact with a surface to be worked on (see FIG. 2 for example).

The material of the board of the brush may be selected for light weight, softness, flexibility, weather resistance, abrasion resistance and tearing resistance depending on target applications. It may be selected as non-abrasive, so as to prevent damaging the finish of the surface the brush is intended to be used on. Boards of closed cells foams, such as EVA (ethylene-vinyl acetate) copolymer foams, polyethylene foams, rubber foams, TPE (thermoplastic elastomer) foams, silicone foams for example, may be used. In the case of materials composed of closed cells for example, which do not absorb water, the board remains flexible even after being completely dipped in and out of water and let to freeze; layers of ice forming on the surface of the foam board may be easily removed by bending the board, thereby breaking the ice. Layer ice surface, if it occurs, is thus easily removed.

The width of the bottom edge and the surface area of the front surface of the brush are selected according to target working edge and working surfaces thereof.

The back and the front plates may be in a plastic material, such as polypropylene for example. Stretchers 114 and 116 may be made in a material, such as nylon reinforced with fiberglass for example, selected for resistance to stress, particularly in the spread out position of the tool head in case the tool is a used as a snow removal tool for example.

The tool of the present disclosure may have a length adjustable between a maximal length in a fully extended position of the pole 14 out of the shaft 112, to a minimum length with the pole 14 retracted, thus hidden, within the shaft 112 as illustrated in FIGS. 3 or 6A for example.

The tool of the present disclosure may be fully retracted into a minimized length of the pole with its tool head folded as shown in FIGS. 3 and 6 for example, when not in use and/ or for storage for example, or extended with adjustable length of the pole.

The scope of the claims should not be limited by the embodiments set forth in the examples, but should be given the broadest interpretation consistent with the description as a whole.

1. A brush, comprising :
a shaft;
a board having lateral sides, a bottom edge, a back surface and a front surface, and symmetrically supported by said shaft;
at least one front plate symmetrically positioned on said front surface of the board relative to said lateral sides and connected to the shaft forward of said board; and
a first and a second back plates on said back surface, each one of the back plates being connected to said shaft by respective stretchers slidingly connected to said shaft rearward of said back surface;
wherein the brush is configured to be in at least one of :
i) a spread out position and ii) a folded position; wherein:
i) in the spread out position, the board extends with said lateral sides thereof away from the shaft on each side of the shaft;
ii) in the folded position, each one of said lateral sides of the board folds backwards towards alignment with the shaft on a respective side of the shaft, under a pulling action of the stretchers backwards on the shaft; and, reversely, a sliding movement of the stretchers forward on the shaft pushes the lateral sides of the board away from the shaft.

2. The brush of claim 1, comprising a first and a second front plates, each one of the front plates being hingedly connected to the shaft forward of the board by a respective hinge.

3. The brush of claim 1, wherein the stretchers are connected to a button slidingly mounted on said shaft.

4. The brush of claim 1, wherein the stretchers are connected to a button slidingly mounted on said shaft; said sliding button comprises a pin configured to insert into an aperture in the shaft to lock a movement of the sliding button along a length of the shaft, thereby locking the sliding button at a corresponding position along the length of the shaft, and to release out of the aperture, thereby releasing the movement of the sliding button along the length of the shaft.

5. The brush of claim 1, wherein said board is a board of foam.

6. The brush of claim 1, wherein said board is a board of closed cells foam.

7. The brush of claim 1, wherein the front plate spans symmetrically relative to the shaft in the spread out position, and is connected to the shaft forward of said board by a living hinge on each side of the shaft.

8. The brush of claim 1, wherein the back and front plates are in a plastic material.

9. The brush of claim 1, wherein the stretchers are in nylon reinforced with fiberglass.

10. A tool, comprising a pole and a brush head a distal end of said pole, wherein the brush head comprises:
a shaft, said shaft having a section larger than a section of said pole;
a board supported by said shaft proximate a tip end of said shaft;
at least one front plate symmetrically positioned on said front surface of the board relative to said lateral sides and connected to the shaft forward of said board;
a first and a second back plates on said back surface, each one of the back plates being connected to said shaft by respective stretchers slidingly connected to said shaft rearward of said back surface;
wherein the brush in configured to be in at least one of : i) a spread out position and ii) a folded position; wherein:
i) in the spread out position, the board extends with said lateral sides thereof away from the shaft on each side of the shaft;ii) in the folded position, each one of said lateral sides of the board folds backwards towards alignment with the shaft on a respective side of the shaft, under a pulling action of the stretchers backwards on the shaft; and, reversely, a sliding movement of the stretchers forward on the shaft pushes the lateral sides of the board away from the shaft.

11. The tool of claim 10, said brush head comprising a first and a second front plates, each one of the front plates being hingedly connected to the shaft forward of the board by a respective hinge.

12. The tool of claim 10, wherein the stretchers are connected to a button slidingly mounted on said shaft.

13. The tool of claim 10, wherein the stretchers are connected to a button slidingly mounted on said shaft; said sliding button comprises a pin configured to insert into an aperture in the shaft to lock a movement of the sliding button along a length of the shaft, thereby locking the sliding button at a corresponding position along the length of the shaft, and to release out of the aperture, thereby releasing the movement of the sliding button along the length of the shaft.

14. The tool of claim 10, wherein said board is a board of foam.

15. The tool of claim 10, wherein said board is a board of closed cells foam.

16. The tool of claim 10, wherein the pole is configured to telescopically move in and out of the shaft at an open end of the shaft.

17. The tool of claim 10, wherein the pole is configured to be one of : i) retracted within the shaft and ii) extended out from the open end of the shaft, by unlocking a button fixedly mounted on the shaft.

18. The tool of claim 10, wherein the shaft and the pole are tubular members.

19. The tool of claim 10, wherein the front plate spans symmetrically relative to the shaft in the spread out position, and is connected to the shaft forward of said board by a living hinge on each side of the shaft.

20. The tool of claim 10, wherein the back and front plates are in a plastic material.
